(19) United States
(12) Patent Application Publication
(10) Pub. No.: US 2014/0274315 A1
(43) Pub. Date: Sep. 18, 2014

(54) PLAYER TO PLAYER (P2P) CASINO

(71) Applicant: Nojuice.com, Inc., Honolulu, HI (US)

(72) Inventors: Adam Jae Chun Lee, Honolulu, HI (US); Mikey Mikela Fujihara, Honolulu, HI (US)

(73) Assignee: Nojuice.com, Inc., Honolulu, HI (US)

(21) Appl. No.: 13/843,750

(22) Filed: Mar. 15, 2013

(51) Int. Cl. G07F 17/32

(52) U.S. Cl. CPC G07F 17/3272; G07F 17/3286
USPC 463/25; 463/42

(57) ABSTRACT

Herein, there is provided a system and method for providing a player-to-player casino able to create a table for play between one or more users playing as house and one or more users playing as player.

### BACKGROUND

Internet based casino games are popular. Games are traditionally structured as player vs. house where the “player” is an individual playing at a disadvantage to the “house.” The house collects a “commission” known as the vigorish, “vig,” “cut,” “take” or simply the “juice.” The juice varies depending on the casino game that is being played. While this format is lucrative for the house, many players do not want to play casino games where the house has a substantial advantage over the player.

Players may find that it is more fun and engaging to rather play directly against another player, whether acting as a house or player, with even odds so as to remove the unfair advantage traditionally given to the house. However, existing systems fail to provide computer implemented systems and methods to allow players to act as both house and player, and to play against each other in a peer to peer setting with even odds.

The foregoing examples of the related art and limitations related therewith are intended to be illustrative and not exclusive. Other limitations of the related art will become apparent upon a reading of the specification and a study of the drawings.

The following examples and aspects thereof are described and illustrated in conjunction with systems, tools, and methods that are meant to be exemplary and illustrative, not limiting in scope. In various examples, one or more of the above-described problems have been reduced or eliminated, while other examples are directed to other improvements.

Herein, there is provided a system and method for providing a player-to-player casino able to create a table for play between one or more users playing as house and one or more users playing as player. Multiple users can play as “the house” on a table. Further, each user can play on multiple tables at one time, whether as the house or as a player. Such a system can be provided electronically via an interface to a computing system. The system can operate via a player-to-player (p2p) engine operating under the supervision of a management engine where the p2p engine provides casino games to users in a p2p environment via an interface.

Advantageously, users can play in an even-odds environment thereby increasing their chances of winning as compared with a traditional casino environment where “the house has the advantage.” Such an environment can provide the users with an improved experience by allowing advantage-free, fair play.

### BRIEF DESCRIPTION OF THE DRAWINGS

FIG. 1 depicts an example of a system for providing a player-to-player casino.

FIG. 2 depicts a flow chart of an example of a method for defining a table for play within a player-to-player casino.

FIG. 3 depicts a flow chart of an example of a method for defining a table for play within a player-to-player casino.

FIG. 4 depicts a flow chart of an example of a method for capitalizing a table for play within a player-to-player casino.

FIG. 5 depicts a flow chart of an example of a method for operating a table for play within a player-to-player casino.

FIG. 6 depicts a flow chart of an example of a method for managing a table within a player-to-player casino.

FIG. 7 depicts a flow chart of an example of a method for auditing a table within a player-to-player casino.

FIG. 8 depicts a flow chart of an example of a method for managing a failed table audit within a player-to-player casino.

FIG. 9 depicts an example of a system for providing a player-to-player casino.

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

FIG. 1 depicts an example of a system 100 for providing a player-to-player casino. FIG. 1 includes game library 110, p2p engine 102, management engine 104, data storage 106 and interface 108.

In the example of FIG. 1, game library 110 can be a programming library of functions useful to provide popular casino games. For example, game library 110 can include a collection of functions for displaying cards, counting chips, rolling dice, or otherwise providing games for a user of a casino game. Such games can include, e.g., craps, roulette, baccarat, or any other known or convenient casino games. New games may be added as they are created.

In the example of FIG. 1, p2p engine 102 can include a computer processor coupled to memory storing instructions for execution by the processor. The p2p engine 102 creates, operates, closes and otherwise runs all tables within the p2p casino. These operations can generate a significant amount of data and the p2p engine 102 is stores such data within data storage 106. Further, the operation of the p2p engine 102 includes the debiting and crediting of user accounts for funds to capitalize a table where associated financial data is stored in data storage 106.

In the example of FIG. 1, management engine 104 can include a computer processor coupled to memory storing instructions for execution by the processor. The management engine 104 can audit records created by p2p engine 102 and has the power to require p2p engine 102 to suspend a table for financial, security or other known or convenient reasons. For example, management unit 104 can perform one or more of the methods included herein to monitor and audit table activity.

In the example of FIG. 1, data storage 106 can be a data repository for storing all information associated with a p2p casino. As used in this paper, a “repository” can be implemented, for example, as software embodied in a physical computer-readable medium on a general-purpose or specific-purpose machine, in firmware, in hardware, in a combination thereof, or in any applicable known or convenient device or system.

The repositories described in this paper are intended, if applicable, to include any organization of data, including tables, comma-separated values (CSV) files, traditional databases (e.g., SQL), or other known or convenient organizational formats.

In an example of a system where a repository is implemented as a database, a database management system (DBMS) can be used to manage the repository. In such a case, the DBMS may be thought of as part of the repository or as part of a database server, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, FileMaker, Informix, Microsoft Access, Microsoft SQL Server, Microsoft Visual FoxPro, MySQL, and OpenOffice.org Base, to name several, however, any known or convenient DBMS can be used.

Database servers can store databases, as well as the DBMS and related engines. Any of the repositories described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

In the example of FIG. 1, interface 108 can be one or more of a graphical user interface for directly communicating with a user at a computing system operating the p2p casino, a data interface operable to service a user via a communications link to a separate computing device, or any known or convenient interface for communicating the operations of the p2p casino with a user. Such an interface can be useful for communicating over a network, such as the internet.

FIG. 2 depicts a flow chart 200 of an example of a method for defining a table for play within a player-to-player casino. The method is organized as a sequence of modules in the flowchart 200, however, it should be understood that these and other modules associated with other methods described herein may be reordered for parallel execution or into different sequences of modules.

In the example of FIG. 2, the flowchart starts at module 202 with create table with pre-defined specifications. In creating a table, a library may be used to provide a table of common use; for example a standard craps table may include definitions for table limits, maximum odds-bets, minimum bet and other known or convenient table specifications. Similarly, standard blackjack or baccarat tables may include similar values relevant to such games. There is some convenience in offering a table with pre-defined specifications; a user may not wish to define all values for a table and may “just want a standard table.”

In the example of FIG. 2, the flowchart continues to module 204 with list table as open for user(s) to join as house. In entering a table as open for user(s) to join as house, the table can be required to specify a minimum of at least one user playing as the house to open the table. Such requirements and availability of the table can be saved to data storage. Once the table is listed, users can view the table, as well as other open tables, via an interface.

In the example of FIG. 2, the flowchart continues to module 206 with collect minimum amount to hold table open from user as house. At least one user, or potentially more than one user, can elect to play as the house. Each such user can be required to have sufficient funds to play as the house; “sufficient funds” can vary from table to table and from game to game, but one method of determining sufficient funds is to identify the maximum loss that the table could experience in a round and require the user to maintain that amount as available. Alternatively, a portion of such maximum loss, e.g. a margin, could be required of the user in order to open the table.

In the example of FIG. 2, the flowchart continues to module 208 with list table as open for play. This table can then be entered into a data store as having met the requirements to allow users to play. Then when a user requests a list of available tables, the table can be provided to the user as a part of that list. Having listed table as open for play, the flowchart terminates.

FIG. 3 depicts a flow chart 300 of an example of a method for defining a table for play within a player-to-player casino. The method is organized as a sequence of modules in the flowchart 300, however, it should be understood that these and other modules associated with other methods described herein may be reordered for parallel execution or into different sequences of modules.

In the example of FIG. 3, the flowchart starts at module 302 with create table for user that wishes to play as house. Here a user can be requesting a table as well as the power to operate the table as the house. For example, the user may wish to limit the number of players to a certain sized table, restrict players to his or her friends, set a table limit of a certain dollar amount, or otherwise define the table to his or her specific specifications.

In the example of FIG. 3, the flowchart continues to module 304 with receive user specifications for table. The user can transmit the specifications to the p2p casino via an interface and the specifications can be received and stored into a data store for the p2p casino. Such a transmission can be made by the internet, a local network, direct entry by the user into the computing system, or other known or convenient path.

In the example of FIG. 3, the flowchart continues to module 306 with define table to user specifications. The table specifications can be entered into a data store as defining a particular table. Such specifications can be used by a p2p engine in conjunction with a game library to provide that table. Additionally, a management engine can use the specifications in monitoring and auditing the table.

In the example of FIG. 3, the flowchart continues to module 308 with list table as open. Listing a table as open can include making an entry in a data store that a particular table is open for play. Once the table has been listed as open, users can receive the table in responses to their requests for open tables. Having listed table as open, the flowchart terminates.

FIG. 4 depicts a flow chart 400 of an example of a method for capitalizing a table for play within a player-to-player casino. The method is organized as a sequence of modules in the flowchart 300, however, it should be understood that these and other modules associated with other methods described herein may be reordered for parallel execution or into different sequences of modules.

In the example of FIG. 4, the flowchart starts at module 402 with user joins 1^{st} table. When a user joins a table, the act of joining can be reflected as an entry into a data store. This entry can associate the user with the identified table such that a p2p engine treats the player as a user on the table. Such data can be accessible to both the p2p engine and a management engine in operating and managing the table.

In the example of FIG. 4, the flowchart continues to module 404 with debit user account for funds to capitalize 1^{st} table. A table can have a requirement for the amount of funds needed to play on that table. A p2p engine can debit the required funds from an account associated with that user, or alternatively mark such funds as allocated to the 1^{st} table. Such allocation or debiting can ensure that the user will not fail to make payment to the house for the 1^{st} table, should he or she lose. The amount of the funds can be determined in part by whether the user is playing as the house or as a player. Enough funds should be deducted so that the user will meet his or her maximum loss on that table, or at least a defined portion of that loss if a margin or similar system is used. Further, where the user is playing as the house, the amount can be dependent on the number of other users playing as the house.

In the example of FIG. 4, the flowchart continues to module 406 with user joins 2^{nd} table. The user can play on more than one table at the same time, subject to his or her ability to pay. In joining the second table an entry can be made into a data store specifying that the user is now playing on the identified table. When information about the table is requested the user will be identified as playing on the particular table.

In the example of FIG. 4, the flowchart continues to module 408 with debit user account for funds to capitalize 2^{nd} table. The user's ability to pay for any losses can be ensured when the user joins the table. This can be accomplished by specifying an amount of funds to mark, escrow, set aside or otherwise make available solely for payment of losses to the second table. Having debited user account for funds to capitalize 2^{nd} table, the flowchart terminates.

FIG. 5 depicts a flow chart 500 of an example of a method for operating a table for play within a player-to-player casino. The method is organized as a sequence of modules in the flowchart 500, however, it should be understood that these and other modules associated with other methods described herein may be reordered for parallel execution or into different sequences of modules.

In the example of FIG. 5, the flowchart starts at module 502 with user(s) join as house. The user can be required to have sufficient funds to cover losses by the house and can place those funds into an account associated with the table. One or more users can operate as the house, thereby sharing the wins and losses from the table.

In the example of FIG. 5, the flowchart continues to module 504 with user(s) join as player(s). One or more users can join the table as a player. Each such user can provide a minimum amount required to play a round on the table. Such an amount can vary from game to game.

In the example of FIG. 5, the flowchart continues to module 506 with play round. The table plays a round of a current game, that players play against the house according to the rules of the particular game, for example, craps, baccarat, blackjack, or any known or convenient game.

In the example of FIG. 5, the flowchart continues to module 508 with performing the following for each player. This module refers to repeating the remaining modules below, including module 510 and then module 512 through 516 or alternatively, module 518 through 522 for each player on the table.

In the example of FIG. 5, the flowchart continues to decision module 510 with determining whether player is a winner in round. The player is determined to be a winner in the round in accordance with the rules of the game being played on the particular table, e.g. the rules of blackjack, the rules of roulette, or rules of another known or convenient game. If the decision at 510 is no the flowchart proceeds to module 512. If the decision at 510 is yes then the flowchart proceeds to module 518.

In the example of FIG. 5, if the decision at 510 is no, the flowchart continues from decision module 510 to module 512 with debit player account for loss. In accordance with the rules for the game being played, an amount for the loss is deducted from the player's account.

In the example of FIG. 5, the flowchart continues to module 514 with divide loss by number of users playing as house. This calculation will determine the amount of winnings each user playing as house will receive from this specific player.

In the example of FIG. 5, the flowchart continues to module 516 with credit accounts of users playing as house with portion of loss. This credit will deliver the winnings each user playing as house will receive from this specific player. Having credited accounts of users playing as house with portion of loss, the flowchart terminates.

In the example of FIG. 5, if the decision at 510 is yes, the flowchart continues from decision module 510 to module 518 with divide win by number of users playing as house. This identifies the portion of the player's win that must be paid by each individual user playing as house.

In the example of FIG. 5, the flowchart continues to module 520 with debit users playing as house for portion of value of the win. The amount required from each user playing as house is collected from the user's account.

In the example of FIG. 5, the flowchart continues to module 522 with credit player with value of win. Here, the amount collected in the previous module can be delivered to the winning player. Having credited player with value of win, the flowchart terminates.

FIG. 6 depicts a flow chart 600 of an example of a method for managing a table within a player-to-player casino. The method is organized as a sequence of modules in the flowchart 600, however, it should be understood that these and other modules associated with other methods described herein may be reordered for parallel execution or into different sequences of modules.

In the example of FIG. 6, the flowchart starts at module 610 with monitor listeners for table activity. Software in memory, executing on a processor, can be used to provide the table with a listener, or function that collects table data. A management engine can collect the table activity or table data from the listener. The information can be useful for analysis of the activities on the table, such as for auditing and security purposes.

In the example of FIG. 6, the flowchart continues to module 612 with store table activity in database. The data received from the listener can be stored in a data storage repository, e.g. a database such as any discussed within this paper. The data can be organized by table, by game, by user, player, or any other known or convenient schema.

In the example of FIG. 6, the flowchart continues to module 614 with perform an audit of activity. The audit of the data collected from the listener can be analyzed, e.g. by a management engine for irregularities, insufficient funds, security breaches, user requirements or any known or convenient audit factor. Having performed an audit of activity, the flowchart terminates.

FIG. 7 depicts a flow chart 700 of an example of a method for auditing a table within a player-to-player casino. The method is organized as a sequence of modules in the flowchart 700, however, it should be understood that these and other modules associated with other methods described herein may be reordered for parallel execution or into different sequences of modules.

In the example of FIG. 7, the flowchart starts at module 702 with table audit triggered. A table audit can be triggered at the end of every round, where a security violation is detected, or where any known or convenient need for an audit is raised.

In the example of FIG. 7, the flowchart continues to module 704 with perform table audit. In performing the table audit, the auditing process can perform one or more tests required for the audit, including checking that sufficient funds are available for each user on the table, that any data checksums or hash values are accurate, that user computing systems are all responding to requests or any other known or convenient test.

In the example of FIG. 7, the flowchart continues to decision module 706 with determining whether action is required. The decision can be yes where action is required and the decision can be no where action is not required. Action can be required by any rule controlling the table, e.g. a requirement of the game being played, insufficient funds, security violation, or other known or convenient requirement. For example, action can be required by the loss of player funds below a level at which the player could pay should he lose another round. If the decision at 706 is no the flowchart proceeds to module 708. If the decision at 706 is yes then the flowchart proceeds to module 710.

In the example of FIG. 7, if the decision at 706 is no, the flowchart continues from decision module 706 to module 708 with play next round. Assuming the audit has completed successfully, the next round can be played. Having played the next round, the flowchart terminates.

In the example of FIG. 7, if the decision at 706 is yes, the flowchart continues from decision module 706 to module 710 with take audit action. An individual audit action can be an action designed to remedy a particular issue, e.g., where there are insufficient funds the user can be required to add funds. Where there are not enough players to play the game, the game play can be halted while new players are identified. Any other audit action can be identified and applied as needed.

In the example of FIG. 7, the flowchart continues to decision module 712 with determining whether the action is complete. An action can require time to complete or may involve multiple steps. Where the table has not completed the current action or where a subsequent step is required in an action the flowchart remains at module 712 with evaluating and re-evaluating until such time as the audit action has been completed. The decision can be yes where the audit action has completed, or alternatively, the decision can be no where the action has not completed. If the decision at 712 is no the flowchart proceeds back to module 712. If the decision at 712 is yes then the flowchart proceeds back to module 704.

FIG. 8 depicts a flow chart 800 of an example of a method for managing a failed table audit within a player-to-player casino. The method is organized as a sequence of modules in the flowchart 800, however, it should be understood that these and other modules associated with other methods described herein may be reordered for parallel execution or into different sequences of modules.

In the example of FIG. 8, the flowchart starts at module 802 with audit action fails for insufficient funds. A user playing as house can be audited to determine whether the user has enough funds to cover bets for all users playing as player. A user playing as player can be audited to determine whether the user has sufficient funds to make and cover bets. A common audit failure will occur where a user has nm out of money. This is particularly important where the user is playing as the house because the table depends on the house to satisfy wins of players. Where a user has insufficient funds, and where no margin, loan or other system has been put into place to prevent a user from running out of funds, the audit action for sufficient funds can fail.

In the example of FIG. 8, the flowchart continues to module 804 with suspend table. If a user has insufficient funds he cannot be allowed to continue play until funds have been added to his account. A user can have a master account and a table account. Where only the table account is exhausted, the user can supply funds to the table account from the master account. Additionally a user can supply funds to the master account from outside sources. The table can be suspended where, e.g., there is no user playing as house or no user playing as house having sufficient funds to cover the bet(s) made by a user playing as player on the table. Where a user playing as player has insufficient funds that user may be required to add funds before continuing play. However, the table can typically be allowed to continue play while the user playing as player adds funds.

In the example of FIG. 8, the flowchart continues to decision module 806 with determining whether additional funds have been received. After a brief delay a check can be performed to determine whether the user has added funds. Alternatively, the system can alert the management engine that the funds have been received and the decision module can be evaluated. The decision can be no where the funds have not been added and the decision can be yes where the funds have been added. If the decision at 806 is no, the flowchart proceeds to module 808 with closing the table. In closing the table, user accounts can be credited and the users disassociated from the table. Further the table can be removed from the list of active tables. Having closed the table, the flowchart terminates.

In the example of FIG. 8, if the decision at 806 is yes, the flowchart continues from decision module 806 to module 810 with credit account. Once the additional funds have been received the funds can be stored into an account associated with the table.

In the example of FIG. 8, the flowchart continues to module 812 with determine whether the audit action is complete. This entry can notify the management engine that the particular audit event associated with insufficient funds has been completed. If there are any other audit events unrelated to funding, they may need to be resolved before returning to play. Having determined that the audit action is complete, the flowchart terminates.

FIG. 9 depicts an example of a system for providing a player-to-player casino. The system 900 may be a conventional computer system that can be used as a client computer system, such as a wireless client or a workstation, or a server computer system. The system 900 includes a device 902, I/O devices 904, and a display device 906. The device 902 includes a processor 908, a communications interface 910, memory 912, display controller 914, non-volatile storage 916, I/O controller 918, clock 922, and radio 924. The device 902 may be coupled to or include the I/O devices 904 and the display device 906.

The device 902 interfaces to external systems through the communications interface 910, which may include a modem or network interface. It will be appreciated that the communications interface 910 can be considered to be part of the system 900 or a part of the device 902. The communications interface 910 can be an analog modem, ISDN modem or terminal adapter, cable modem, token ring IEEE 802.5 interface, Ethernet/IEEE 802.3 interface, wireless 802.11 interface, satellite transmission interface (e.g. “direct PC”), WiMAX/IEEE 802.16 interface, Bluetooth interface, cellular/mobile phone interface, third generation (3G) mobile phone interface, code division multiple access (CDMA) interface, Evolution-Data Optimized (EVDO) interface, general packet radio service (GPRS) interface, Enhanced GPRS (EDGE/EGPRS). High-Speed Downlink Packet Access (HSPDA) interface, or other interfaces for coupling a computer system to other computer systems.

The processor 908 may be, for example, a conventional microprocessor such as an Intel Pentium microprocessor or Motorola power PC microprocessor. The memory 912 is coupled to the processor 908 by a bus 920. The memory 912 can be Dynamic Random Access Memory (DRAM) and can also include Static RAM (SRAM). The bus 920 couples the processor 908 to the memory 912, also to the non-volatile storage 916, to the display controller 914, and to the I/O controller 918.

The I/O devices 904 can include a keyboard, disk drives, printers, a scanner, and other input and output devices, including a mouse or other pointing device. The display controller 914 may control in the conventional manner a display on the display device 906, which can be, for example, a cathode ray tube (CRT) or liquid crystal display (LCD). The display controller 914 and the I/O controller 918 can be implemented with conventional well known technology.

The non-volatile storage 916 is often a magnetic hard disk, flash memory, an optical disk, or another form of storage for large amounts of data. Some of this data is often written, by a direct memory access process, into memory 912 during execution of software in the device 902. One of skill in the art will immediately recognize that the terms “machine-readable medium” or “computer-readable medium” includes any type of storage device that is accessible by the processor 908.

Clock 922 can be any kind of oscillating circuit creating an electrical signal with a precise frequency. In a non-limiting example, clock 922 could be a crystal oscillator using the mechanical resonance of vibrating crystal to generate the electrical signal.

The radio 924 can include any combination of electronic components, for example, transistors, resistors and capacitors. The radio is operable to transmit and/or receive signals.

The system 900 is one example of many possible computer systems which have different architectures. For example, personal computers based on an Intel microprocessor often have multiple buses, one of which can be an I/O bus for the peripherals and one that directly connects the processor 908 and the memory 912 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 912 for execution by the processor 908. A typical computer system will usually include at least a processor, memory, and a bus coupling the memory to the processor.

In addition, the system 900 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 916 and causes the processor 908 to execute the various acts required by the operating system to input and output data and to store data in memory, including storing files on the non-volatile storage 916.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is Appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present example also relates to apparatus for performing the operations herein. This Apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, flash memory, magnetic or optical cards, any type of disk including floppy disks, optical disks, CD-ROMs, and magnetic-optical disks, or any type of media suitable for storing electronic instructions, and each coupled to a computer system bus.

The algorithms and displays presented herein are not inherently related to any particular computer or other Apparatus. Various general purpose systems may be used with programs in accordance with the teachings herein, or it may prove convenient to construct more specialized Apparatus to perform the required method steps. The required structure for a variety of these systems will appear from the description below. In addition, the present example is not described with reference to any particular programming language, and various examples may thus be implemented using a variety of programming languages.

What is claimed is:

1. A system comprising:
a p2p engine creating a table for play between a first user playing as house and a second user playing as player;
an interface coupled to the p2p engine receiving data from users playing as house and users playing as players; and
a management engine coupled to the p2p engine auditing the table.

2. The system of claim 1, wherein the p2p engine collects table activity data from the table for analysis.

3. The system of claim 1, wherein the management engine identifies insufficient funds for the first user playing as house and requires the table to cease play until sufficient funds are added by the first user.

4. The system of claim 1, wherein the management engine identifies insufficient funds for the second user playing as player and allows the table to continue play, but requires the second user to cease play on the table until sufficient funds are added by the second user.

5. The system of claim 1, wherein a third user joins as player and the second user and third user each individually play against the first user playing as house.

6. A method comprising:
in memory coupled to a processor, executing instructions to monitor a table for activity of a current round of play between a first user playing as house and a second user playing as player;
storing the activity in a database; and
performing an audit to identify sufficient funds of the first user and the second user to perform a next round of play.

7. The method of claim 6, further comprising, receiving user specifications for the table and defining the table to the user specifications prior to engaging the first user and the second user in play on the table.

8. The method of claim 6, further comprising, receiving a request from a third user to join as house along with the first user playing as house and collectively playing the third user and first user as house against the second user playing as a player.

9. The method of claim 6, further comprising, receiving a request from a third user to join as player along with the second user playing as player and collectively playing the third user and second user as players against the first user playing as house.

10. A method comprising:
receiving, via an interface into memory coupled to a processor, a request to join a table as a first user playing as house;
receiving a second request to join the table as a second user playing as player;
operating the table for a round of play;
debiting an account associated with the first user playing as house in response to a win by the second user playing as the player; and
crediting an account for the second user playing as the player in response to the win by second user playing as the player.

11. The method of claim 10, further comprising, defining the table in response to a request from the first user to create a table.

12. The method of claim 10, further comprising, collecting a minimum amount to open the table from the first user playing as house.

13. The method of claim 10, further comprising, listing the table as open for play to users playing as house and users playing as player.

14. The method of claim 10, further comprising, receiving a request from a third user to play as house and collecting funds from the third user before allowing that third user to join the table.

15. The method of claim 10, further comprising, auditing table activity to determine that an action is required before resuming play.

16. The method of claim 10, further comprising, suspending the table in response to an audit determining that no user playing as house has sufficient funds to cover a bet made by a user playing as player.

17. The method of claim 10, further comprising debiting a user account for a house win and crediting a portion of the house win to the first user playing as house and then crediting one or more other users playing as house with their respective portions of the house win.

18. The method of claim 10, further comprising, receiving a request from a third user to join as player along with the second user playing as player and individually playing the third user and second user as players against the first user playing as house.
